(19) United States
(12) Patent Application Publication
(10) Pub. No.: US 2017/0051888 A1
(43) Pub. Date: Feb. 23, 2017

(54) DUAL GLOBE LIGHTING DEVICE

(71) Applicant: Lava Lite, L.L.C., Elk Grove Village, IL (US)

(72) Inventors: Michael Kehrmann, Elk Grove Village, IL (US); Yan Xiang Lin, Zhongshan (CH)

(73) Assignee: Lava Lite, L.L.C.

(21) Appl. No.: 14/832,068

(22) Filed: Aug. 21, 2015

(51) Int. Cl. F21S 10/00; F21V 17/08; F21V 14/00

(52) U.S. Cl. CPC F21S 10/002; F21V 14/00; F21V 17/08; F21W 2121/00

(57) ABSTRACT

A lighting device for displaying liquid globules that float and change shapes within a liquid. The device has a base that supports a globe that contains a liquid. A second inner tube is supported in the globe and contains a second liquid and globules that when heated float and change shapes within the second inner tube. The globe may optionally have globules or other materials disbursed in the globe. Similarly the inner tube may have colorant or other matter disbursed in the second liquid. A light source provides the light and heat to make the device operational.

### BACKGROUND

This invention relates to lighting devices and more particularly to a novelty or decorative lighting device. The general background relates to lighting devices in which a globe or container has at least two substances, one of which has a heavier specific gravity and forms globules and the other having a lesser specific gravity. The two substances are immiscible with each other. The first or heavier substance is substantially solid at room temperature or is so viscous at room temperature that it will not emulsify with the other liquid. When heat is applied to the container, the first substance will become flowable and move about in the other substance forming floating globules. This type of lamp is illustrated in U.S. Pat. No. 3,387,396 issued to David Smith and currently sold under the registered trademark LAVA LITE owned by Lava Lite, LLC, the assignee of the present application.

### SUMMARY OF THE INVENTION

The invention provides a novelty lighting device in which the device has a base portion that houses a lamp that provides a light and heat source. The base portion supports a globe that has an inner cavity that is filled with a liquid. Supported within the globe is an inner tube that has a second liquid and globules within the inner tube. The bottom of the inner tube is mounted in close proximity to the lamp so that the when the lamp is energized, it heats the bottom of the inner tube causing the globules to rise and form floating shapes in the second liquid. The globe may also have globules or other substances disposed in the liquid to form additional visual effects.

### BRIEF DESCRIPTION OF THE DRAWINGS

FIG. 1 is a cross sectional view of the lighting device in which the inner tube is mounted to the cap of the lighting device.

FIG. 2 is a cross section al view of a first alternative embodiment in which the inner tube is mounted to a plate that is supported by the top of the globe.

FIG. 3 is a cross sectional view of a second alternative embodiment in which the inner tube is mounted in a flexible substance that is inserted into the top of the globe.

### DESCRIPTION OF THE PREFERRED EMBODIMENT

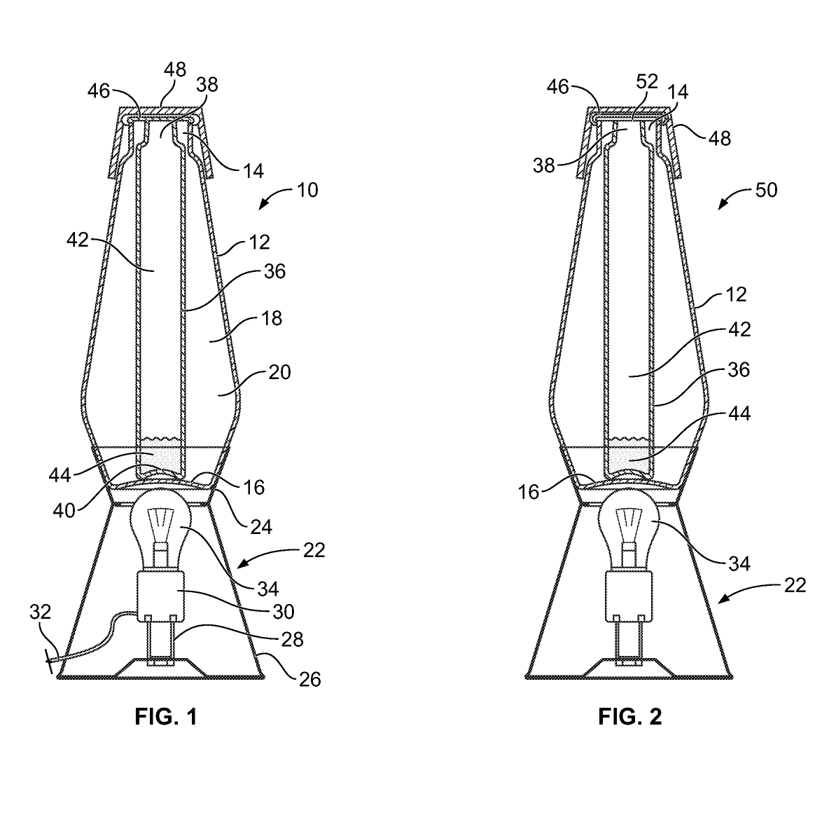

Turning first to FIG. 1, there is illustrated a first embodiment of an inventive lighting device 10. The lighting device 10 is a motion lamp that provides a lighted display with changing globules as will be described in greater herein.

There is a globe 12 having an open top 14 and a bottom 16 which thus forms an outer cavity 18 which contains a first liquid 20. The lighting device 10 has a base 22 formed from an upper base portion 24 and lower base portion 26. The upper base portion 24 and lower base portion 26 are frustro conical shapes with the smaller tapered portions joined together as seen in FIG. 1. The base 22 includes a mounting bracket 28 that supports a lamp socket 30 that is connected to a power source by means of a power cord 32. This provides power to a light bulb 34 that provides both light and heat to the lighting device 10. In other arrangements the light bulb 34 may be a LED light source and a separate heat source may be provided.

Mounted within the outer cavity 18 in the globe 12 is an inner tube 36, which is made from transparent or translucent material, preferably glass. The inner tube 36 has a top 38 and an inner tube bottom 40. It is filled with a second liquid 42. There are globules 44 at the inner tube bottom 40 that are gel like at room temperature and become fluid like when heated. These materials are known in the art such as originally taught in U.S. Pat. No. 3,387,396. The inner tube 36 may also have other substances disposed in the second liquid 42 such as a coloring agent or glitter. The inner tube bottom 40 is in close proximity and preferably in contact with the globe bottom 16. The globe 12 is designed to fit within and be supported by the upper base portion 24 so that the globe bottom 16 is just above the top of the bulb 34. Thus the heat from the bulb 34 heats the globe bottom 16 and the inner tube bottom 36. This in turn heats the liquid globules 44 causing them to liquefy and float in various forms within the second liquid 42. The globules 44 and second liquid 42 are immiscible in each other so that the globules remain separate and distinct from the second liquid 42.

The top 38 of the inner tube 36 is attached to a sealing cap 46 such that when the sealing cap 46 is attached in a conventional manner to the open top 14 of the globe 12, it forms a liquid tight seal. One conventional method of sealing may be done by crimping the edges of the cap 46 to the periphery of the open top 14. Other methods are known to those in the art as long as it accomplished the intended purpose. A cover 48 may also be provided to enclose the cap 46 with an esthetically pleasing cover to hide the cap 46 and the top 38 of the inner tube 36.

In the alternate embodiment illustrated in FIG. 2, the same reference numbers as used in the first embodiment will be used for the same components. The second embodiment illustrates a second lamp 50 that operates in the same manner as the first embodiment. There is an inner tube 36 that has a top 38 similar to the first embodiment. However, the difference between the two embodiments resides in the mechanism to attach the top 38 to the sealing cap 46. In the second embodiment, the top 38 is affixed to a plate 52 that has a diameter substantially the same as the outer diameter of the open top 14 of the globe 12. The plate 52 rests on the open top 14 and the sealing cap 46 is crimped onto the open top 14 which holds the plate in place against the open top 14. In all other aspects the alternate embodiment operates the same as the first embodiment.

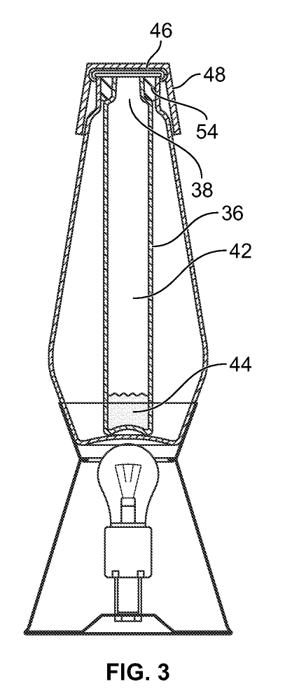

In the second alternate embodiment illustrated in FIG. 3, again the same reference numbers will be used. The third embodiment operates the same as the first and second embodiments with the difference being the manner in which the inner tube 36 is mounted inside the globe 12. In the third embodiment the top 38 of the inner tube is mounted in a rubber like or wax type substance that forms a plug 54. The plug 54 is inserted into the open top 14 and forms a liquid tight seal that retains the inner tube 36 in place while keeping the first liquid in the globe 12 and the second liquid 42 within the inner tube 36.

In any of the embodiments the first liquid 20 may have added to it globules, coloring agent, glitter or other materials to form various lighting arrangements and color schemes. Additionally there may be added one or more additional inner tubes adjacent to the first inner tube so that the additional tubes can present new and different arrangements with the same or different globules that change shapes when heated.

Thus there has been provided a novelty lighting device which has been described in conjunction with specific embodiments. It is evident that many alternatives, modifications and variations will be apparent to those skilled in the art in light of the foregoing description. Accordingly, it is intended to embrace all such alternatives, modifications and variations as fall within the spirit and scope of the appended claims.

1. A decorative lamp comprising:
a base;
a globe portion having an open top, a bottom and a wall defining an inner cavity, a cap configured to be mounted to the top of the globe portion, the cap forming a liquid tight seal between the cap and the ton of the globe, a first liquid contained within the inner cavity of the globe portion,
an inner glass rube having a upper end and lower end, the inner glass tube containing a second liquid and liquid globules, the inner glass tube extending from the cap towards the base with the lower end of the inner glass tube in close proximity to the bottom of the globe, and the upper end is sealed to maintain the second liquid therein and maintaining the second liquid separate from the first liquid at all times,
a light source supported by the base portion for illuminating the globe portion;
a heat source positioned in the base in close proximity to the bottom of the globe and configured to heat the liquid globules in the inner glass tube.

2. The lighting device of claim 1 wherein the base is comprised of a frustro conically shaped lower base portion and an inverted frustro conically shaped upper base portion.

3. The lighting device of clam 1 wherein the light source is also the heat source.

4. (canceled)

5. The lighting device of claim 1 wherein the upper end of the inner glass tube is mounted to the cap.

6. The lighting device of claim 1 wherein the upper end of the inner glass tube is mounted to a plate that is supported by the top of the globe.

7. The lighting device of claim 6 wherein the cap is attached to the top of the globe and secures the plate between the cap and he top of the globe.

8. The lighting device of claim 1 and further comprising a second inner tube having an upper and lower end and containing a third liquid and liquid globules, the second inner tube extending from the cap towards the base with the lower end of the second inner tube in close proximity to the bottom of the globe.

9. The lighting device of claim 8 wherein the upper end of he second inner tube is mounted to the cap.

10. The lighting device of claim 8 wherein the upper end of the second inner tube is mounted to a plate that is supported by the top of the globe.

11. The lighting device of claim 10 wherein the cap is attached to the top of the globe and secures the plate between the cap and the top of the globe.

12. The lighting device of claim I and further comprising a glitter like material disposed in any one of the first or second liquids.

13. The lighting device of claim 1 and further comprising liquid globules disposed in the first liquid.
